(19) United States
(12) Patent Application Publication
(10) Pub. No.: US 2005/0132160 A1
(43) Pub. Date: Jun. 16, 2005

(54) Platform independent method for establishing a run-time data area

(76) Inventors: Gerald L. Everett, Alta, CA (US); Gregory T. Andersen, Meridian, ID (US); Sam Miller, Chicago, IL (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/737,106

(22) Filed: Dec. 15, 2003

(51) Int. Cl. G06F 12/00; G06F 9/00

(52) U.S. Cl. 711/170; 713/2

(57) ABSTRACT

In one embodiment, a firmware module is relocated from a read-only memory location to a writeable memory location during a system boot-up operation. A portion of the writeable memory location is reserved which comprises a memory allocation for the firmware module and an additional memory allocation. Without prior knowledge of system resource allocation, the additional memory allocation is designated as a run-time data area.

### TECHNICAL FIELD

Embodiments of the present invention relate to the field of data processing. More specifically, embodiments of the present invention are directed to a method for establishing a writeable data area during a boot-up operation.

### BACKGROUND ART

System boot firmware is typically stored in Read Only Memory (ROM) and is used to boot and configure a computer system and to support an operating system running on top of the firmware. System firmware requires writeable memory locations, also referred to as “scratch RAM,” in order to save information regarding the system such as state information. In systems using platform dependent firmware, prior knowledge of system resource allocation (e.g., the location in memory where the scratch RAM can be accessed, how to access it, etc.) is needed when programming the firmware module.

When creating a platform specific or platform dependent firmware module, known system resource allocation (e.g., the location in memory where the scratch RAM can be accessed, how to access it, etc.) is used to expose the platform scratch RAM to the module. That is, the location in memory where the scratch RAM can be accessed, how to access it, etc., is coded into the module.

However, whenever a change is made to the system platform, the system resource allocation may change, thus requiring a change of the firmware module as well. Thus, changes to the platform are complicated by the fact that the firmware modules must changed as well so that they can continue to access system resources such as scratch RAM. As a result, production cycles may be lengthened and additional costs incurred to change the firmware module when changes to the platform are implemented as well as distributing the new module commercially.

For this reason, platform independent firmware modules would be preferable because there would be no need to change the firmware module when changes are made to the system platform. However, when creating platform-independent firmware modules, any one type of platform specific system resource allocation information cannot be used as each platform may have different or unique system resource allocation information. Therefore, as an example, an address offset to the scratch memory cannot be hard-coded into the system firmware module. As a result, a platform-independent firmware module is needed which is operable without requiring system resource allocation information.

### DISCLOSURE OF THE INVENTION

In one embodiment, a firmware module is relocated from a read-only memory location to a writeable memory location during a system boot-up operation. A portion of the writeable memory location is reserved which comprises a memory allocation for the firmware module and an additional memory allocation. Without prior knowledge of system resource allocation, the additional memory allocation is designated as a run-time data area.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 is a block diagram of an exemplary computer system upon which embodiments of the present invention may be implemented.

FIG. 2A is a block diagram depicting the transfer of a firmware module from a read only memory to a writeable memory in accordance with embodiments of the present invention.

FIG. 2B is a block diagram, showing in greater detail, system resource allocation in accordance with embodiments of the present invention.

FIG. 3 is a flowchart of a computer implemented method for establishing a run-time data area in accordance with embodiments of the present invention.

FIG. 4 is a flowchart of a method for creating a system independent run-time data storage area in accordance with embodiments of the present invention.

FIG. 5 is a flowchart of a method for creating a run-time data area in accordance with embodiments of the present invention.

FIG. 6 is a block diagram of an exemplary computer system upon which embodiments of the present invention may be implemented.

### MODES FOR CARRYING OUT THE INVENTION

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “relocating,” “reserving,” “designating,” “receiving,” “returning,” “determining,” “intercepting,” “utilizing,” “allocating,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

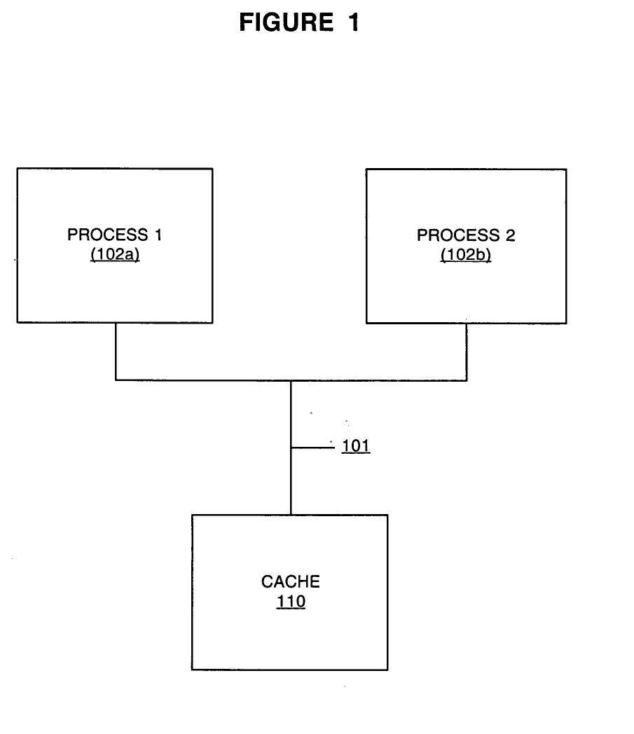

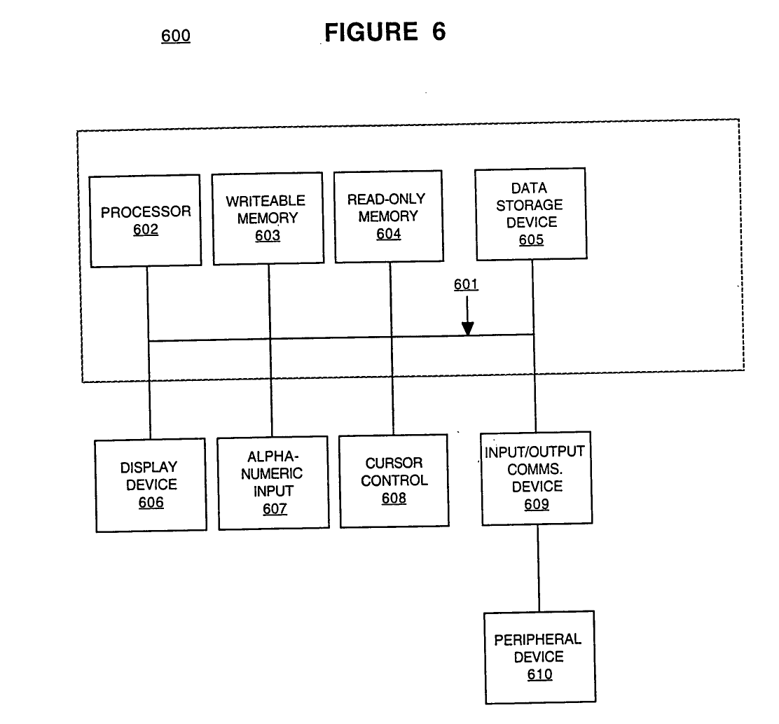

FIG. 1 is a block diagram of an exemplary computer system upon which embodiments of the present invention may be implemented. In the embodiment of FIG. 1, a first process (e.g., process 102a) and a second process (e.g., process 102b) are coupled with a cache 110 via a bus 101. In embodiments of the present invention, a common cache may be provided for 2 or more processors. It is appreciated that additional components may be utilized with system 100 and have been omitted for clarity. In embodiments of the present invention, a firmware component disposed at a read-only memory location (e.g., non-volatile memory 604 of FIG. 6) is relocated to a writeable memory location (e.g., volatile memory 603 of FIG. 6) during a system boot-up operation.

In the embodiment of FIG. 1, a firmware module for controlling cache 110 is relocated to a writeable memory location during system boot-up. In accordance with one embodiment of the present invention, when the firmware module is relocated to the writeable memory location, the present invention reserves a portion of the writeable data area for the firmware module. Additionally, the present invention reserves an additional portion of the writeable memory location and designates the additional portion as a run-time data area. The run-time data area can then be used by the firmware module as needed. In so doing, the present invention establishes a writeable memory location for system firmware without a requirement for prior knowledge of system resource allocation. More specifically, in the present embodiment, there is no requirement to know the address offset to scratch RAM when hard coding the read-only memory module. Thus, in this embodiment, the run-time data area can also be used by system firmware features to store, for example, machine state information, data, error seeding information, memory address pointers, etc. Therefore, the present invention can be used to establish a platform independent firmware module because, rather than requiring a platform-specific writeable memory area, the location of the writeable memory location is specified by the firmware module itself.

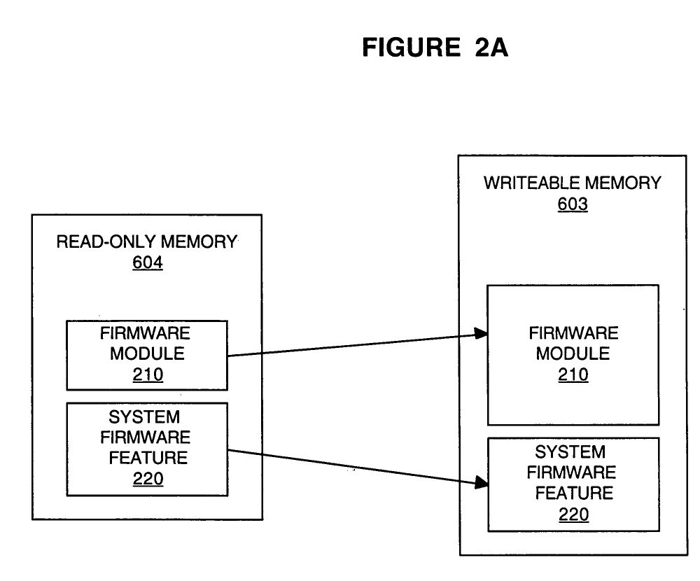

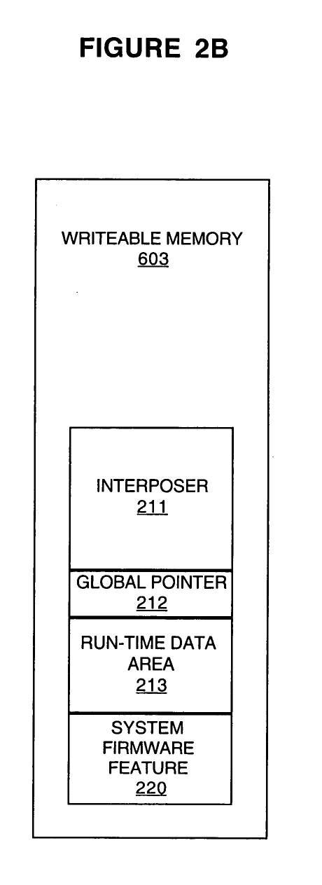

FIG. 2A is a block diagram depicting the transfer of a firmware module 210 from a read only memory 604 to a writeable memory 603 in accordance with embodiments of the present invention. In the embodiment of FIG. 2A, a firmware module 210 and a system firmware feature 220 are stored upon read-only memory 604. In many computer systems, some system firmware features are written to a writeable memory location (e.g., to RAM) 603 during a system boot-up operation. The system firmware feature 220 is then disabled for the read-only memory 604 and the system firmware feature 220 is accessed by accessing the writeable memory 603 location to which the system firmware feature 220 was written.

In the embodiment of FIG. 2A, firmware module 210 and system firmware feature 220 are relocated to writeable memory 603 during the boot-up operation. In embodiments of the present invention, firmware module 210 intercepts system calls between system firmware feature 220 and the computer operating system during the boot-up process. This intercepting is performed in a manner that is transparent to the computer system. When system firmware feature 220 is relocated to writeable memory 603, firmware module 210 is relocated as well.

In one embodiment, system firmware feature 220 comprises a processor abstraction layer (PAL) utilized in implementations of the Itanium® processor family commercially available from the Intel® Corporation of Sunnyvale, Calif. While the present embodiment recites the Itanium® processor family specifically, embodiments of the present invention are well suited to be implemented with other computer systems and/or processors. In the present embodiment, the PAL firmware abstracts processor-implementation specific features such as procedure calls, error recovery routines, processor self-test routines, etc., and also contains code needed to initially boot the processor. In the embodiment of FIG. 2A, when the PAL (e.g., system firmware feature 220) is written to writeable memory 603, firmware module 210 generates commands causing it to be written to writeable memory 603 as well. While the present embodiment recites relocating firmware feature 210 with the PAL, embodiments of the present invention are well suited for relocating firmware module 210 with a variety of system firmware features.

In the present embodiment, firmware module 210 reserves a larger amount of writeable memory 603 than it occupies in read-only memory 604. In other words, the present invention reserves additional space in writeable memory 603 than is actually needed for the coding of the firmware module 210 itself. In embodiments of the present invention, this additional space in writeable memory 603 is designated as the run-time data area which can be used as a writeable data area for system firmware features (e.g., system firmware feature 220)and for firmware module 210.

There are a variety of methods for reserving an additional memory allotment for firmware module 210 in accordance with embodiments of the present invention. In one embodiment, the present invention compiles a static data structure into firmware module 210 read-only memory 603 that includes additional space for a run-time data area when firmware module is hard coded into read-only memory 604. Initially the data structure of firmware module 210 is not writeable due to the fact that is in read-only memory 604. However, upon relocating firmware module 210 to writeable memory 603, the data area can be used by firmware module 210 and system firmware feature 220 as needed.

In another embodiment, the present invention initiates reserving an allotment of writeable memory 603 for firmware module 210, another allotment of writeable memory 603 for system firmware feature 220, and an additional allotment of writeable memory 603 that is designated as a writeable run-time data area. When firmware module 210 relocates to writeable memory 603, the additional memory allocation is designated to be used as the run-time data area and can be used by firmware module 210 and system firmware feature 220 as needed.

In the present embodiment, firmware module 210 continues to interpose upon procedure calls between the operating system and the platform hardware via the PAL after being relocated to writeable memory 603. In one embodiment, firmware module 210 also acts as a cache controller for cache 210 after being relocated to writeable memory 603 and is used during operations for controlling cache such as: cache flushing, cache initialization, direct memory access (DMA), etc.

The following discussion is directed to one method of relocating firmware module 210 with a system firmware feature (e.g., system firmware feature 220) in accordance with embodiments of the present invention. In one embodiment of the present invention, the present invention interposes firmware module 210 between system firmware feature 220 (e.g., the PAL procedures) and the rest of the system. For example, during the boot-up process an address is sent to the PAL module disposed on read-only memory 604 of a register that will be used as a temporary storage location until the PAL module is relocated to a writeable memory location. In embodiments of the present invention, firmware module 210 intercepts the system call sending this address and saves the address of the register.

In the present embodiment, firmware module 210 intercepts a target entry point which is sent from the operating system to the PAL which will be used as the entry point to the PAL during system calls. Firmware module 210 saves this address in the temporary storage location and passes back to the system a new entry point which is the entry point of firmware module 210. The new entry point is then used by the system as a fixed entry point into firmware module 210 (e.g., when system calls are made to the PAL). This facilitates intercepting system calls to the PAL once the PAL and firmware module 210 are relocated to writeable memory 603 in a manner that is transparent to the operating system. Additionally, because the size of firmware module 210 is known, the offset to the run-time data area and to the PAL can be calculated from the fixed entry point into firmware module 210. As a result, a hard coded address to scratch RAM is not necessary in embodiments of the present invention. Instead the memory location of the run-time data area and the PAL is relative to the entry point into firmware module 210. Additionally, as the location of both the run-time data area and the PAL are both relative to the entry point into firmware module 210, the PAL can access the run-time data area as needed.

Next, a system call for determining the size of the PAL (e.g., the system firmware feature 220 of FIG. 2A) is intercepted by firmware module 210. In the present embodiment, firmware module 210 determines the size of system firmware feature 220, and sends a response that reserves a portion of writeable memory 603. However, rather than only reporting the size the PAL module, firmware module 210 sends a response which reserves a portion of writeable memory 603 sufficient to store firmware module 210, the PAL module (e.g., system firmware feature 220 of FIG. 2B) and an additional allotment for a run-time data area (e.g., run-time data area 213 of FIG. 2B). The address of a portion of writeable memory 603 is sent to which these components will be relocated. When the PAL is relocated (copied) into writeable memory 603, the present invention relocates firmware module 210 with the PAL to the writeable memory location of writeable memory 603. As described above, firmware module 210 may be compiled to include an additional area that is used as a run-time data area, or may reserve an additional amount of writeable memory 603 for that purpose. In the present embodiment, the present invention writes a “signature word” when firmware module 210 and system firmware feature 220 are relocated to writeable memory 603 to verify that run-time data area 213 has been properly initialized and is ready for storing data. This also prevents storing data in the wrong data area as it can be used to verify the correct memory location.

FIG. 2B is a block diagram, showing in greater detail, system resource allocation in accordance with embodiments of the present invention. As shown in FIG. 2B, writeable memory 603 comprises an interposer 211, a global pointer 212, a run-time data area 213 and system firmware feature 220. As described above, when system firmware feature 220 is relocated from read-only memory to a writeable memory location, firmware module 210 relocates with system firmware feature 220 and intercepts system calls to system firmware feature 220. In the embodiment of FIG. 2B, firmware module 210 has relocated to writeable memory 603 and is now comprises interposer 211, global pointer 212, and run-time data area 213. As discussed above, in other embodiments of the present invention, the run-time data area may be implemented by hard coding a data structure into interposer 211 that can be used as a writeable data area for interposer 211 and/or system firmware feature 220.

In embodiments of the present invention, interposer 211 stores the addresses of the register areas it controls in run-time data area 213. In embodiments of the present invention, during the boot process the operating system may make system calls which are intercepted by interposer 211 for registering virtual addresses for these registers. Interposer 211 sends the base address of the register area, and the operating system returns a virtual address for the register area which is stored by interposer 211 in run-time data area 213. In embodiments of the present invention, interposer 211 determines when a process (e.g., process 102a of FIG. 2) is running in real mode and uses the address stored in run-time data area 213 to access the registers. Alternatively, interposer 211 can detect when a process (e.g., process 102a of FIG. 1) is running in a virtual mode. Upon determining this, interposer 211 accesses the virtual address stored in run-time data area 213. Thus, embodiments of the present invention operate in a manner that is transparent to the operating system in both the real and virtual mode.

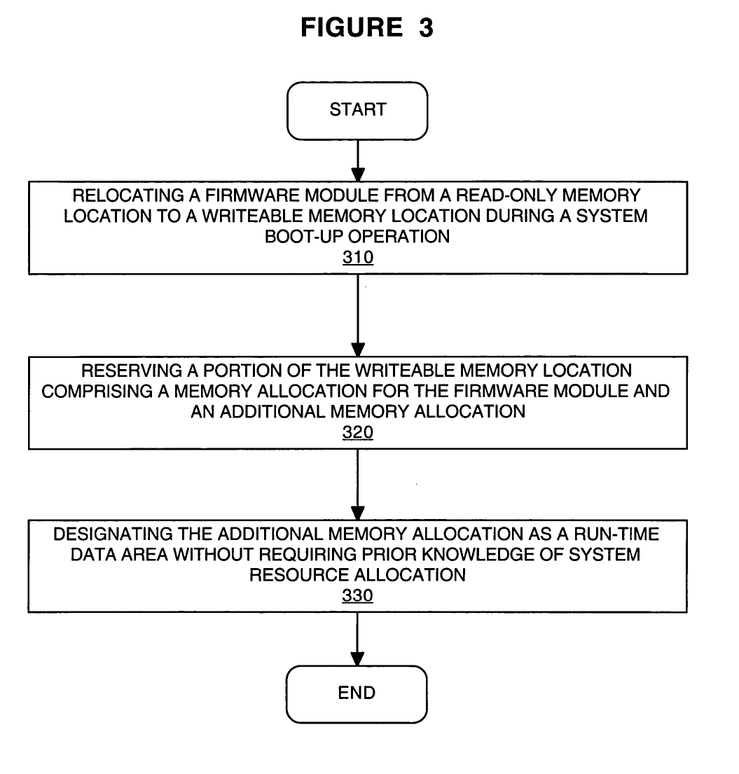

FIG. 3 is a flowchart of a computer implemented method 300 for establishing a run-time data area in accordance with embodiments of the present invention. In step 310 of FIG. 3, the present invention relocates firmware module 210 from a read-only memory 604 to a writeable memory 603 during a system boot-up operation. As discussed above with reference to FIG. 2A, firmware module 210 is relocated to writeable memory 603 from read-only memory 604 when a system firmware feature is relocated during a boot-up operation.

In step 320 of FIG. 3, a portion of writeable memory 603 is reserved which comprises a memory allocation for firmware module 210 and an additional memory allocation. As discussed above with reference to FIG. 2A, during the relocation of firmware module 210 to writeable memory 603, the present invention reserves an additional portion of writeable memory 603. In one embodiment, the additional portion of writeable memory 603 is separate from firmware module 210. In another embodiment, the additional portion of memory 603 is a data structure compiled into firmware module 210 when the read-only memory is fabricated.

In step 330 of FIG. 3, the present invention designates the additional memory allocation as a run-time data area without requiring prior knowledge of system resource allocation. As discussed above with reference to FIG. 2A, the additional memory allocation is designated as a run-time data area and can be used to store system state information and for the temporary storage of data that can be used by firmware module 210 and/or system firmware feature 220 as needed. Advantageously, access to the run-time data area is referenced from the entry point into the firmware module (e.g., the entry point into interposer 211 of FIG. 2B) it is relocated to writeable memory. Thus, the present invention allows access to a writeable memory location for system firmware that is not referenced to a fixed memory location. As a result, the present invention facilitates creating platform independent firmware modules which can utilize writeable memory 603 without the necessity of prior knowledge of system resource allocation.

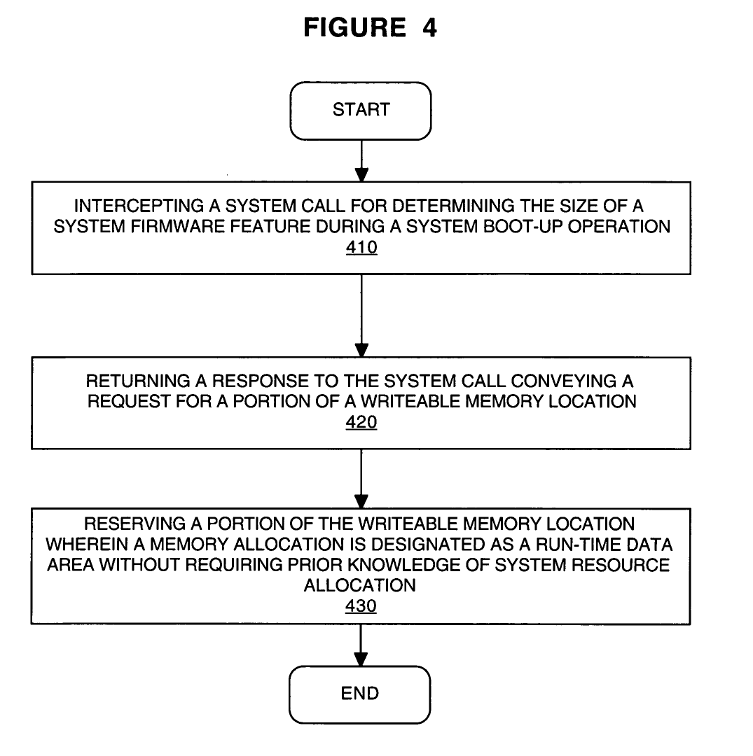

FIG. 4 is a flowchart of a method 400 for creating a system independent run-time data storage area in accordance with embodiments of the present invention. In step 410 of FIG. 4, the present invention intercepts a system call for determining the size of a system firmware feature during a system boot-up operation. As discussed above with reference to FIG. 2A, firmware module 210 of the present invention intercepts system calls to the system firmware feature 220 (e.g., a processor abstraction layer (PAL) module) during the boot-up process and later when relocated to writeable memory 603.

In step 420 of FIG. 4, the present invention returns a response to the system call which conveys a request for a portion of a writeable memory location. As discussed above with reference to FIG. 2A, firmware module 210 sends a reply to the system call of step 410 reserving a portion of a writeable memory 603. In embodiments of the present invention, firmware module 210 reserves an additional portion of writeable memory 603 which may be used as a run-time data area.

In step 430 of FIG. 4, the present invention reserves a portion of the writeable memory 603 and designates it as a run-time data area without requiring prior knowledge of system resource allocation. As discussed above with reference to FIG. 2A, when the system firmware feature 220 (e.g., the PAL) and firmware module 210 are relocated to writeable memory, firmware module 210 reserves an additional portion of writeable memory 603 (e.g., run-time data area 213) and designates it as a run-time data area. The present invention designates this as the run-time data area without requiring prior knowledge of system resource allocation.

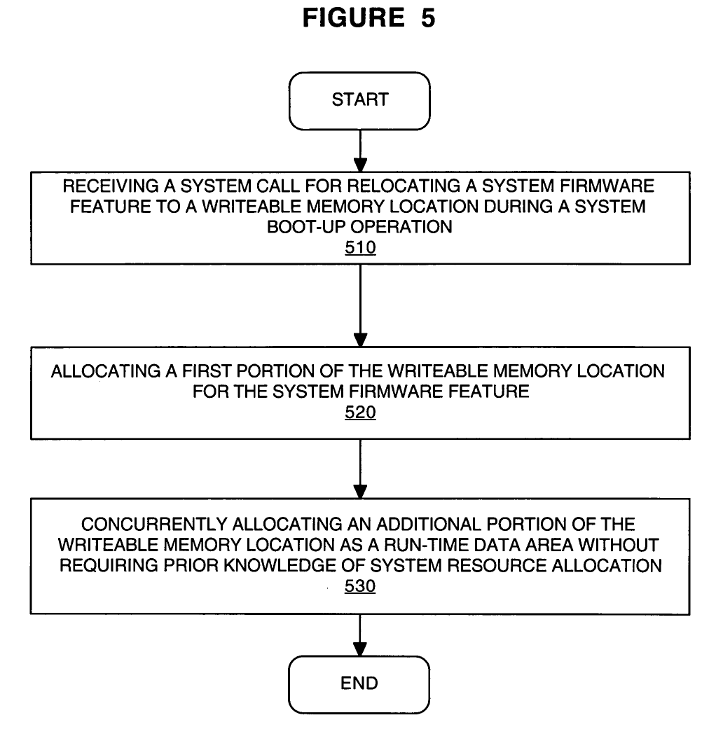

FIG. 5 is a flowchart of a method 500 for creating a run-time data area in accordance with embodiments of the present invention. In step 510 of FIG. 5, firmware module 210 of the present invention receives a system call for relocating a system firmware feature to writeable memory 603 during a system boot-up operation. As discussed above with reference to FIG. 2A, the system call to a system firmware feature 220 is intercepted by firmware module 210 during the system boot-up operation. In the present embodiment, the present invention returns an entry point into firmware module 210 to the operating system which the operating system then uses when accessing the system firmware feature 220.

In step 520 of FIG. 5, a first portion of writeable memory 603 is allocated for system firmware feature 220. As discussed above with reference to FIG. 2A, a system call is sent to system firmware feature 220 to determine how much writeable memory is needed when relocating system firmware feature 220. Firmware module 210 of the present invention intercepts this system call and sends a response which reserves a first portion of the writeable memory location for system firmware feature 220. Additionally, firmware module 210 reserves a portion of writeable memory 603 for itself prior to relocating to the writeable memory area.

In step 530 of FIG. 5, an additional portion of the writeable memory location is allocated as a run-time data area without requiring prior knowledge of system resource allocation. As discussed above with reference to FIG. 2A, the present invention allocates an additional portion of writeable memory 603 for a run-time data area when firmware module 210 and system firmware feature 220 are relocated to writeable memory 603 during the boot-up process. In embodiments of the present invention, the run-time data area may comprise a data structure compiled into firmware module 210, or may be a separate portion (e.g., run-time data area 213 of FIG. 2B) of writeable memory 603. The present invention designates a portion of writeable memory 603 as a run-time data area 213 without requiring prior knowledge of system resource allocation. This is possible because the location of run-time data area 213 is relative to the entry point into firmware module 210 rather than at a pre-determined memory location within writeable memory 603.

With reference to FIG. 6, portions of the present invention are comprised of computer-readable and computer-executable instructions that reside, for example, in computer system 600 which is used as a part of a general purpose computer network (not shown). It is appreciated that computer system 600 of FIG. 6 is exemplary only and that the present invention can operate within a number of different computer systems including general-purpose computer systems, embedded computer systems, laptop computer systems, hand-held computer systems, and stand-alone computer systems.

In the present embodiment, computer system 600 includes an address/data bus 601 for conveying digital information between the various components, a central processor unit (CPU) 602 for processing the digital information and instructions, a writeable memory 603 comprised of, for example, volatile random access memory (RAM) for storing the digital information and instructions, and a read-only memory 604 for storing information and instructions of a more permanent nature. In addition, computer system 600 may also include a data storage device 605 (e.g., a magnetic, optical, floppy, or tape drive or the like) for storing vast amounts of data.

Devices which are optionally coupled to computer system 600 include a display device 606 for displaying information to a computer user, an alpha-numeric input device 607 (e.g., a keyboard), and a cursor control device 608 (e.g., mouse, trackball, light pen, etc.) for inputting data, selections, updates, etc. Computer system 600 can also include a mechanism for emitting an audible signal (not shown).

Returning still to FIG. 6, optional display device 606 of FIG. 6 may be a liquid crystal device, cathode ray tube, or other display device suitable for creating graphic images and alpha-numeric characters recognizable to a user. Optional cursor control device 608 allows the computer user to dynamically signal the two dimensional movement of a visible symbol (cursor) on a display screen of display device 606. Many implementations of cursor control device 608 are known in the art including a trackball, mouse, touch pad, joystick, or special keys on alpha-numeric input 607 capable of signaling movement of a given direction or manner displacement. Alternatively, it will be appreciated that a cursor can be directed an/or activated via input from alpha-numeric input 607 using special keys and key sequence commands. Alternatively, the cursor may be directed and/or activated via input from a number of specially adapted cursor directing devices.

Furthermore, computer system 600 can include an input/output (I/O) signal unit (e.g., interface) 609 for interfacing with a peripheral device 610 (e.g., a computer network, modem, mass storage device, etc.). Accordingly, computer system 600 may be coupled in a network, such as a client/server environment, whereby a number of clients (e.g., personal computers, workstations, portable computers, minicomputers, terminals, etc.) are used to run processes for performing desired tasks.

The preferred embodiment of the present invention, a computer implemented method for establishing a run-time data area, is thus described. While the present invention has been described in particular embodiments, it should be appreciated that the present invention should not be construed as limited by such embodiments, but rather construed according to the following claims.

1. A computer implemented method for establishing a run-time data area comprising:
relocating a firmware module from a read-only memory location to a writeable memory location during a system boot-up operation;
reserving a portion of said writeable memory location comprising a memory allocation for said firmware module and an additional memory allocation; and
designating said additional memory allocation as said run-time data area, wherein said run-time data area is created without requiring prior knowledge of system resource allocation.

2. The computer implemented method as recited in claim 1 wherein said relocating further comprises:
receiving a system call for a system firmware feature; and
returning a response to said system call requesting said memory allocation for said firmware module, said additional memory allocation, and a memory allocation for said system firmware feature.

3. The computer implemented method as recited in claim 2 further comprising:
determining the size of said system firmware feature;
determining the size of said firmware module; and
determining the size of said run-time data area.

4. The computer implemented method as recited in claim 2 wherein said system firmware feature comprises a processor abstraction layer.

5. The computer implemented method as recited in claim 1 wherein said firmware module operates in a real mode.

6. The computer implemented method as recited in claim 1 wherein said firmware module operates in a virtual mode.

7. The computer implemented method as recited in claim 1 wherein said firmware module is dynamically operable in a real mode and a virtual mode.

8. A method for creating a system independent run-time data storage area comprising:
intercepting a system call for determining the size of a system firmware feature during a system boot-up operation;
returning a response to said system call conveying a request for a portion of a writeable memory location; and
reserving a portion of said writeable memory location, wherein a memory allocation is designated as said run-time data area, wherein said run-time data area is created without requiring prior knowledge of system resource allocation.

9. The method as recited in claim 8 further comprising:
utilizing a firmware module resident upon a read-only memory location to perform said intercepting.

10. The method as recited in claim 9 further comprising:
relocating said system firmware feature and said firmware module from said read-only memory location to said writeable memory location.

11. The method as recited in claim 10 wherein said run-time data area comprises a sub-component of said firmware module.

12. The method as recited in claim 10 wherein said run-time data area is separate from said firmware module and said system firmware feature.

13. The method as recited in claim 8 wherein said system boot-up operation is performed by an Intel Itanium® processor.

14. The method as recited in claim 13 wherein said system firmware feature comprises a processor abstraction layer.

15. The as recited in claim 9 wherein said firmware module operates in a real mode.

16. The method as recited in claim 9 wherein said firmware module operates in a virtual mode.

17. The method as recited in claim 9 wherein said firmware module is dynamically operable in a real mode and a virtual mode.

18. A method for creating a run-time data area comprising:
receiving a system call for relocating a system firmware feature from a read-only memory location to a writeable memory location during a system boot-up operation;
allocating a first portion of said writeable memory location for said system firmware feature; and
allocating an additional portion of said writeable memory location and designating said additional memory allocation as said run-time data area, wherein said run-time data area is created without requiring prior knowledge of system resource allocation.

19. The method as recited in claim 18 wherein said system firmware feature comprises a processor abstraction layer.

20. The method as recited in claim 18 further comprising:
using a firmware module to perform said intercepting.

21. The method as recited in claim 20 further comprising:
allocating a third portion of said writeable memory location to said firmware module.

22. The method as recited in claim 20 further comprising:
allocating said additional portion of said writeable memory location to said firmware module; and
designating a portion of said firmware module as said run-time data area.

23. The method as recited in claim 20 wherein said firmware module operates in a real mode.

24. The computer implemented method as recited in claim 20 wherein said firmware module operates in a virtual mode.

25. The computer implemented method as recited in claim 20 wherein said firmware module is dynamically operable in a real mode and a virtual mode.
